(19) United States
(12) Patent Application Publication
(10) Pub. No.: US 2008/0265566 A1
(43) Pub. Date: Oct. 30, 2008

(54) PIPE-FITTING APPARATUS FOR BY-PASSING CONDUIT

(76) Inventor: Bill J. Renfro, Richmond, TX (US)

Correspondence Address: ROBERT R. WATERS, ESQ.;WATERS LAW OFFICE, PLLC, 633 SEVENTH STREET, HUNTINGTON, WV, 25701, US

(21) Appl. No.: 12/028,304

(22) Filed: Feb. 8, 2008

Related U.S. Application Data
(60) Provisional application No. 60/926,682, filed on Apr. 27, 2007.

(51) Int. Cl. F16L 41/00

(52) U.S. Cl. 285/122.1

(57) ABSTRACT

A pipe-fitting apparatus comprises a housing having a first conduit pathway and a second conduit pathway, the first conduit pathway formed by a pair of apertures disposed on the housing and aligned coaxially, the first conduit pathway formed within the housing and separately enclosed from the interior of the housing. The first conduit pathway carries fluid of a first conduit line. The second conduit pathway formed by a pair of apertures disposed on the housing and aligned coaxially, the second conduit pathway formed within the housing and enclosed by the housing. The second conduit pathway carrying the fluid of a second conduit line. The first conduit pathway and the second conduit pathway are aligned substantially within the same plane and angularly disposed relative to one another.

### RELATED U.S. APPLICATION DATA

This application claims the benefit of U.S. Provisional Application No. 60/926,682 filed on Apr. 27, 2007.

### FIELD OF THE INVENTION

This application relates generally to a pipe-fitting apparatus, and, more specifically, this application relates to a pipe-fitting apparatus permitting the by-pass of one or more conduit lines by other conduit lines.

### BACKGROUND OF THE INVENTION

A particular problem with conduit lines, especially multiple conduit lines in a multi-floor building, involves the routing of waste lines relative to vent lines, and vice versa. It is often desirable to interconnect multiple vent lines that approach a specific area of the conduit or plumbing system. However, interconnection is often difficult and tedious because of the number of interconnections that must be achieved and the labor involved in cutting pathways for other lines.

Applicant is unaware of any apparatus or device that overcomes the difficulties cited above, especially with regard to the apparatus disclosed herein. Applicant's apparatus allows a plumbing vent line or stack to be interconnected with another vent line on the opposite side of a waste line or stack while remaining within the wall line or plane. As such, Applicant's apparatus is an improvement in the art.

### SUMMARY OF THE INVENTION

In one embodiment, a pipe-fitting apparatus is disclosed, the apparatus comprising a housing, a first conduit pathway formed within the housing and separately enclosed from the interior of the housing, a second conduit pathway formed within the housing and enclosed by the housing, and

the first conduit pathway and the second conduit pathway are aligned substantially within the same plane and angularly disposed relative to the other.

In another embodiment, a pipe-fitting apparatus is disclosed, the apparatus comprising a housing having a first conduit pathway and a second conduit pathway, the first conduit pathway formed by a pair of apertures disposed on the housing and aligned coaxially, the first conduit pathway formed within the housing and separately enclosed from the interior of the housing, the first conduit pathway carrying fluid of a first conduit line, the second conduit pathway formed by a pair of apertures disposed on the housing and aligned coaxially, the second conduit pathway formed within the housing and enclosed by the housing, the second conduit pathway carrying the fluid of a second conduit line,

the first conduit pathway and the second conduit pathway are aligned substantially within the same plane and angularly disposed relative to one another.

In another embodiment, a pipe-fitting apparatus accommodating a plurality of conduit lines, the apparatus comprising a housing having at least two conduit pathways receiving and supporting two conduit lines separately, each one of the conduit pathways formed by a pair of apertures disposed on the housing and aligned coaxially, at least two of the conduit pathways parallelly aligned, and a first aperture disposed on the housing receiving a third conduit line.

In the aforementioned embodiments, the first conduit pathway may be defined by the first conduit line inserted through the housing, thereby enclosing the first conduit pathway separately from the housing.

In the aforementioned embodiments, the first conduit pathway may be enclosed by a connector traversing the pair of apertures.

In the aforementioned embodiments, the apparatus may further comprise a plurality of collars, wherein each one of the plurality of collars is separately coupled to the housing at each one of the apertures. Each one of the collars has a diameter larger than the diameter of the conduit line seated therein. One pair of the collars is coupled to the pair of apertures forming the first conduit pathway, the first conduit pathway enclosed by a connector traversing the pair of apertures and the pair of collars coupled thereto. Similarly, one pair of the collars is coupled to the pair of apertures forming the second conduit pathway. Each one of the conduit lines is seated and secured to each one of the collars via attachment means.

Before explaining at least one embodiment of the invention in detail, it is to be understood that the claims are not limited in its application to the details of construction and to the arrangement of the components set forth in the following description or illustrated in the drawings. The description is capable of other embodiments and of being practiced and carried out in various ways. Also, it is to be understood that the phraseology and terminology employed herein are for the purpose of description and should not be regarded as limiting.

Accordingly, those skilled in the art will appreciate that the conception upon which this apparatus is based may readily be utilized as a basis for the design of other structures, methods, and systems for carrying out the several purposes disclosed herein. It is important, therefore, that the claims be regarded as including such equivalent constructions insofar as they do not depart from the spirit of the claims.

Furthermore, the purpose of the foregoing Abstract is to enable the U.S. Patent and Trademark Office and the public generally, and especially including the practitioners in the art who are not familiar with patent or legal terms or phraseology, to determine quickly from a cursory inspection, the nature and essence of the technical disclosure of the application. The Abstract is neither intended to define the claims of the application, nor is it intended to be limiting to the scope of the invention in any way. It is intended that the application is defined by the claims.

### BRIEF DESCRIPTION OF THE DRAWINGS

FIG. 1 is a perspective view of the apparatus;

FIG. 2 is a front view of the apparatus;

FIG. 3 is a rear view of the apparatus;

FIG. 4 is a side view of the apparatus;

FIG. 5 is a top view of the apparatus;

FIG. 6 is a sectional view of the apparatus taken along A-A of FIG. 1;

FIG. 7 is a perspective view of another embodiment of the apparatus;

FIG. 8 is a front view of another embodiment of the apparatus; and

FIG. 9 is a front view of another embodiment of the apparatus.

### DETAILED DESCRIPTION OF THE EMBODIMENT(S)

The detailed description below is provided in at least one embodiment, and possibly multiple embodiments, and is intended to explain the present invention. It is to be understood that a variety of other arrangements are also possible without departing from the spirit and scope of the present invention, regardless of whether the combinations have been explicitly set forth.

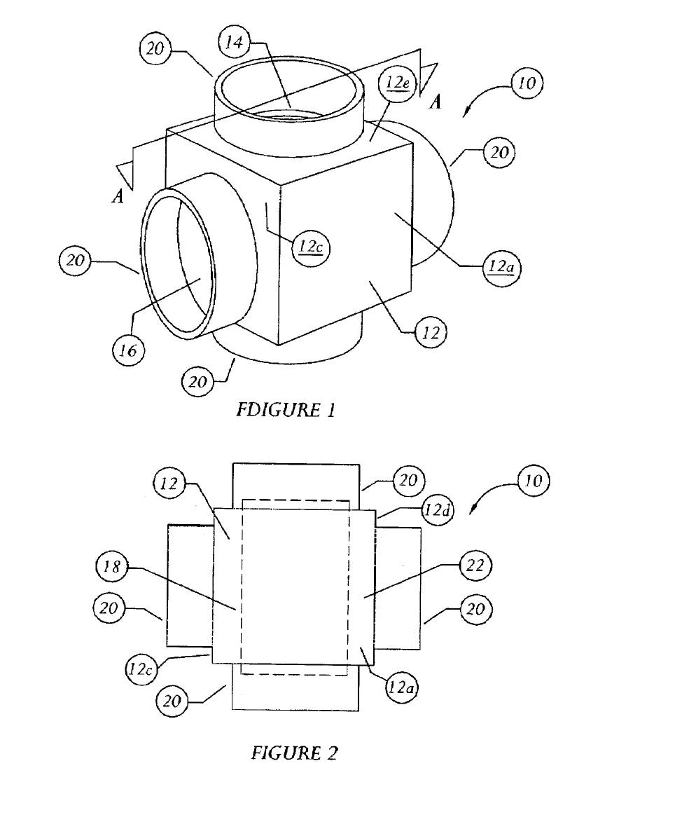

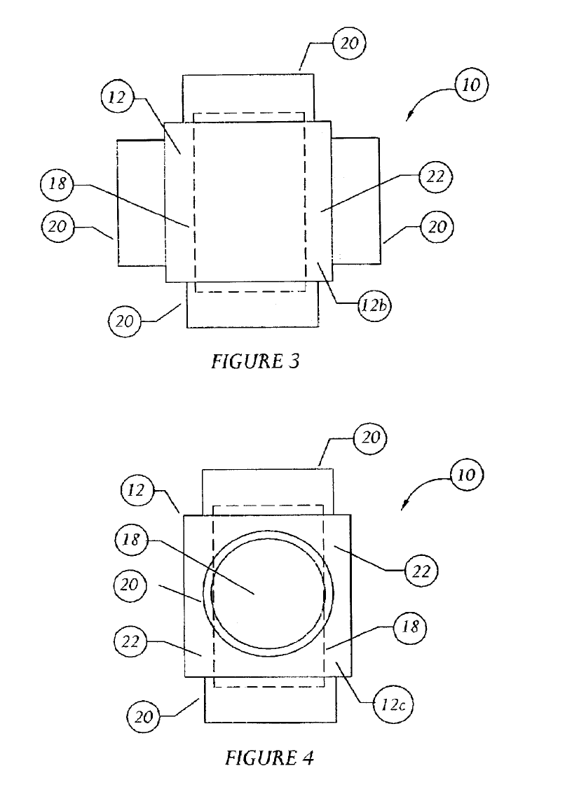

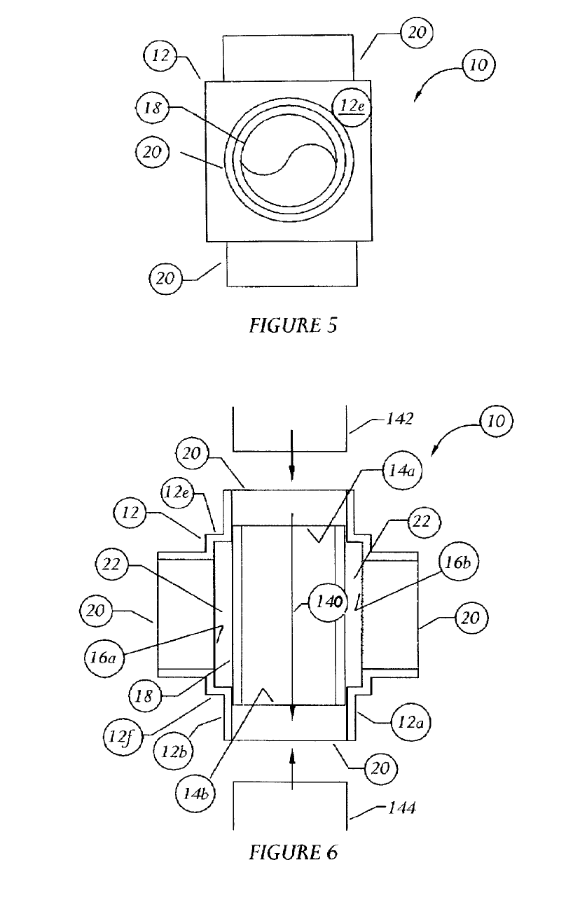

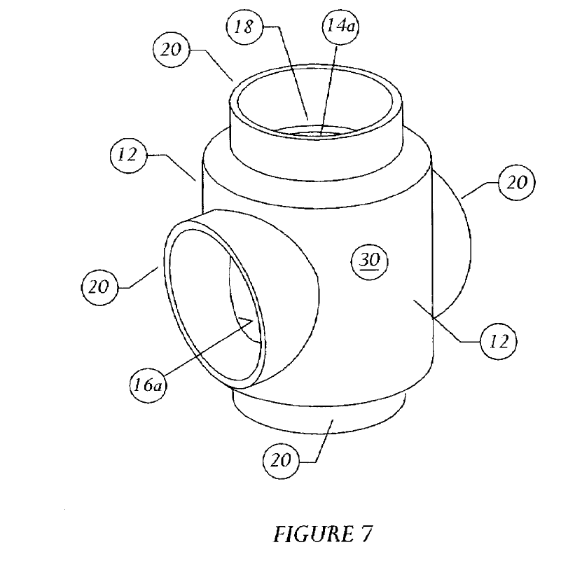

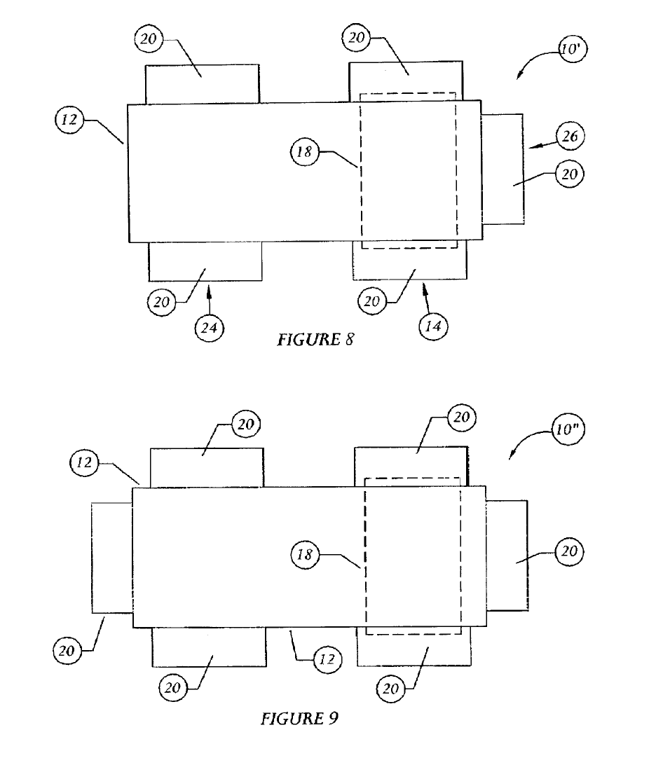

With reference to the figures, specifically FIG. 1 through FIG. 7, a pipe-fitting apparatus is disclosed and generally denoted by the reference character 10, reference character 10′ in FIG. 8 and reference character 10″ in FIG. 9, respectively.

Referring now to FIG. 1 through FIG. 7, one embodiment disclosed describes a pipe-fitting apparatus 10 comprising a housing 12 having a first conduit pathway 14 and a second conduit pathway 16, respectively, the apparatus 10 permitting the cross-over of one or more conduit lines within the dimensions of a wall of a structure (such as a home, office or building). The first conduit pathway 14 is formed within the housing 12 and is separately enclosed from the interior of the housing 12. The first conduit pathway 14 is generally terminally bounded by a pair of apertures 14a and 14b formed on the housing 12 and aligned coaxially so as to form a linear pathway therebetween. The first conduit pathway 14 is responsible for carrying or the transportation of a fluid delivered by a first conduit line 140 coupled to the housing 12. Similarly, the second conduit pathway 16 is formed within the housing 12 and is enclosed by the interior of the housing so that the second conduit pathway 16 is open to the interior 22 of the housing 12, unlike the first conduit pathway 14. The second conduit pathway is generally terminally bounded by a pair of apertures 16a and 16b formed on the housing and aligned coaxially. The second conduit pathway 16 is responsible for carrying or the transportation of a fluid delivered by a second conduit line 160 coupled to the housing 12. Because the second conduit pathway 16 is open to the interior of the housing 12, the pathway travel of the fluid is not as linear as the fluid traveling via the line 140 and through the pathway 14. With regard to spatial orientation, the first conduit pathway and the second conduit pathway are aligned substantially within the same plane and angularly disposed relative to one another, wherein the angular disposition may be through approximately 180 degrees, although it is anticipated that a median range of 90 degrees is desirable. As used herein, the term “fluid” embraces any substance that is capable of flowing and that is capable of changing its shape, including liquid(s) and gas(es), and including liquid(s) or gas(es) in combination with solid material as well. It is envisioned that in many embodiments or applications, that one conduit line will carry air and operate as a venting line in a system (such as plumbing), wherein outside air is induced into the system thereby keeping the vent (drain) line at atmospheric pressure and to ensure that the vent (drain) line will drain by gravity, though the embodiments and applications are not limited to this arrangement exclusively.

It is envisioned that the first conduit pathway 14 may be enclosed in a variety of ways. In one embodiment, the pathway 14 may be enclosed because the first conduit line 140 is inserted through the corresponding apertures 14a and 14b. The physical structure of the first conduit line 140 is not disturbed or disrupted, entering the housing at aperture 14a and exiting the housing at aperture 14b, or vice versa. Therefore, the first conduit line 140 may serve to define the pathway 14 and to separate the pathway from the interior of the housing 12. In another embodiment, the pathway 14 may be enclosed by a connector 18 traversing the pair of apertures 14a and 14b bounding the pathway 14. The connector 18 is a linearly elongated conduit portion of a length sufficient to traverse the distance between the apertures 14a and 14b. In this aspect, a section of the first conduit line 140 is removed, the section length removed approximately equal to the length of the connector 18. Thereafter, the first conduit line is defined by two segments 142 and 144 coupled about the connector 18 to form a continuous first conduit line 140 utilizing the pathway 14 defined by the housing 12. As shall be explained in greater detail below, the apparatus 10 may further include a plurality of collars 20 coupled to the housing 12 at the respective apertures 14a, 14b, 16a, 16b, etc. In this aspect, the terminal ends of the segments 142 and 144, respectively, are seated within a corresponding collar 20.

It is envisioned that the collars 20 each have a diameter larger than the diameter of the terminal end of the conduit that is seated therein. A terminus of each conduit is seated within the respective ends of the connector or coupler 16, and securely coupled thereto, and which may be achieved via attachment means and may include, but is not limited to, adhesive(s), frictional impingement, mechanical couplers or other mechanical attachment means, soldering or welding. In securing the terminus of each conduit within the collars 20 (or in the absence of the collars, securing the terminus of each conduit within the ends of the connector 18 via attachment means), a continuous fluid communication is achieved so that fluid may travel through conduit segment 142 and through the connector 18 and into and through conduit segment 144, or vice versa, to a final destination.

In one embodiment, and as depicted in FIG. 1, for example, the housing 12 may assume the form of a cube, the housing 12 comprising a plurality of walls 12a-12f. The walls 12a-12f are generally orthogonal relative to one another. As but one example, as depicted, wall 12a is mutually opposed with wall 12b; wall 12c is mutually opposed with wall 12d; wall 12e is mutually opposed with wall 12f. In combination, the walls 12a-12f as arranged form the cube-shape housing 12 depicted in FIG. 1 through FIG. 6. As but one example of the possible variations that may be achieved, and as depicted in FIG. 6, apertures 14a and 14b are formed on mutually opposing walls 12e and 12f, respectively, defining pathway 14. Similarly, apertures 16a and 16b are formed on mutually opposing walls 12c and 12d defining pathway 16. Pathway 14 may include connector 18, and at least pathway 16 is without a connector and instead is open to the interior 22 of the housing 12, as described above.

In another embodiment, and as depicted in FIG. 6, the housing 12 has a cylindrical shape comprising a single wall 30 concentric about the imaginary axis of the cylinder housing 12, the wall 30 defining the volume of the interior 22 of the housing 12 therein. In this embodiment, apertures 14a and 14b (not depicted in perspective view) are disposed mutually opposed to and coaxially aligned with one another so as to form pathway 14. Apertures 16a and 16b (also not show in perspective view) are disposed mutually opposed to and coaxially aligned with one another so as to form pathway 16. Pathways 14 and 16 are disposed so that the imaginary axis of pathway 14 bisects with the imaginary axis of pathway 16 at approximately a 90 degree angle. One of the pathways 14 or 16 may include a connector 18, and the other pathway 14 or 16 is without a connector and instead is open to the interior 22 of the housing 12. As depicted, pathway 14 includes the connector 18.

As depicted in FIG. 8, and in another embodiment, it is further envisioned that the apparatus 10′ comprises a housing 12 having a prism-shape. The housing 12 may comprise a pair of pathways 14 and 24 that are parallel relative to one another, and an aperture or inlet 26 that has a directional orientation perpendicular to the directional orientations of the pathways 14 and 24. In this embodiment, one of the pair of pathways 14 or 24 has a connector 18 traversing the distance between the apertures forming the pathway 14 (consistent with the description of the orientation of the pathway 14, apertures 14a and 14b, and connector 18 in prior embodiments). The other remaining pathway 24 is without a connector, and instead is open to the interior 22 of the housing 12. The aperture or inlet 26 is also open to the interior 22 of the housing 12. With regard to the pathway 24 and the inlet 26, fluid may be distributed along a number of lines for ingress or egress through the conduits routed through the apparatus 10. Consistent with previously disclosed embodiments, each pathway 14 and 24 and the inlet 26 correspond with apertures formed on the housing 12, and may also correspond with collars 20 coupled at the apertures. Thus, in this aspect, the apparatus 10′ comprises a housing 12 bearing five apertures and collars 20.

As depicted in FIG. 9, and in another embodiment, it is further envisioned that the apparatus 10″ comprises a housing 12 having a prism-shape similar to that depicted in FIG. 8. In this aspect, the housing comprises an additional aperture or inlet 28 mutually opposed with and coaxially aligned with the aperture or inlet 26 first disclosed in relation to FIG. 8 above. The housing 12 may comprise a pair of pathways 14 and 24 that are parallel relative to one another, and a pair of apertures or inlets 26 and 28 that form another pathway 32 that has a directional orientation perpendicular to the directional orientations of the pathways 14 and 24. In this embodiment, one of the pair of pathways 14 has a connector 18 traversing the distance between the apertures forming the pathway 14. The other remaining pathways 14 or 32 are without a connector, and instead are open to the interior 22 of the housing 12, again consistent with the previously disclosed embodiments regarding these elements. It is also envisioned that each of the parallel pathways 14 and 24 may comprise a connector 18 individually, if so desired.

It is envisioned that the apparatus and its various embodiments 10, 10′ and 10″ may be fabricated from a variety of materials, including metal, plastic, composites or other suitable material. It is anticipated that polyvinyl chloride (PVC) and other similar materials will be the preferred materials for fabrication to correspond with the general use of PVC conduit lines in most construction projects. It is further envisioned that the scale of the apparatus and its various embodiments may vary to accommodate the variety of scales used in construction, including small, intermediate and large conduit lines. The apparatus is not limited in scope by either the materials, size, shape, coloring or general construction of the apparatus.

What is claimed is:

1. A pipe-fitting apparatus comprising:
a housing;
a first conduit pathway formed within the housing and separately enclosed from the interior of the housing;
a second conduit pathway formed within the housing and enclosed by the housing; and
the first conduit pathway and the second conduit pathway are aligned substantially within the same plane and angularly disposed relative to the other.

2. A pipe-fitting apparatus comprising:
a housing having a first conduit pathway and a second conduit pathway;
the first conduit pathway formed by a pair of apertures disposed on the housing and aligned coaxially, the first conduit pathway formed within
the housing and separately enclosed from the interior of the housing, the first conduit pathway carrying fluid of a first conduit line;
the second conduit pathway formed by a pair of apertures disposed on the housing and aligned coaxially, the second conduit pathway formed within the housing and enclosed by the housing, the second conduit pathway carrying the fluid of a second conduit line;
the first conduit pathway and the second conduit pathway are aligned substantially within the same plane and angularly disposed relative to one another.

3. The apparatus of claim 2, wherein the housing is a shape consisting of a member selected from a cube, a cylinder and a prism.

4. The apparatus of claim 2, wherein the first conduit pathway is defined by the first conduit line inserted through the housing, thereby enclosing the first conduit pathway separately from the housing.

5. The apparatus of claim 2, wherein the first conduit pathway is enclosed by a connector traversing the pair of apertures.

6. The apparatus of claim 2 further comprising a plurality of collars, wherein each one of the plurality of collars is separately coupled to the housing at each one of the apertures.

7. The apparatus of claim 6, wherein each one of the collars has a diameter larger than the diameter of the conduit line seated therein.

8. The apparatus of claim 7, wherein one pair of the collars is coupled to the pair of apertures forming the first conduit pathway, the first conduit pathway enclosed by a connector traversing the pair of apertures and the pair of collars coupled thereto.

9. The apparatus of claim 7, wherein one pair of the collars is coupled to the pair of apertures forming the second conduit pathway.

10. The apparatus of claim 7, wherein each one of the conduit lines is seated and secured to each one of the collars via attachment means.

11. A pipe-fitting apparatus accommodating a plurality of conduit lines, the apparatus comprising:
a housing having at least two conduit pathways receiving and supporting two conduit lines separately;
each one of the conduit pathways formed by a pair of apertures disposed on the housing and aligned coaxially;
at least two of the conduit pathways parallelly aligned; and
a first aperture disposed on the housing receiving a third conduit line.

12. The apparatus of claim 11, wherein the housing comprises a prism-shape.

13. The apparatus of claim 11, wherein at least one of the two of the conduit pathways parallelly aligned is defined by one of the conduit lines inserted through the housing, thereby enclosing the first conduit pathway separately from the housing.

14. The apparatus of claim 11, wherein at least one of the two of the conduit pathways parallelly aligned is enclosed by a connector traversing the pair of apertures bounding the at least one of the two of the conduit pathways.

15. The apparatus of claim 11 further comprising a plurality of collars, wherein each one of the plurality of collars is separately coupled to the housing at each one of the apertures.

16. The apparatus of claim 15, wherein each one of the collars has a diameter larger than the diameter of the conduit seated therein.

17. The apparatus of claim 16, wherein one pair of the collars is coupled to the pair of apertures forming at least one of the two of the conduit pathways parallelly aligned, the at least one of the two of the conduit pathways parallelly aligned is enclosed by a connector traversing the pair of apertures and the pair of collars coupled thereto.

18. The apparatus of claim 16, wherein one of the collars is coupled to the first aperture.

19. The apparatus of claim 18 further comprising a second aperture disposed on the housing and mutually opposed with the first aperture so that the first aperture and the second aperture are aligned coaxially.

20. The apparatus of claim 16, wherein each one of the conduit lines is seated and secured to each one of the collars via attachment means.
